(19) United States
(12) Patent Application Publication
(10) Pub. No.: US 2024/0236838 A1
(43) Pub. Date: Jul. 11, 2024

(54) APPLICATION FUNCTION (AF) PROVISIONING STATIC INTERNET PROTOCOL (IP) ADDRESSES TO USER EQUIPMENTS

(71) Applicant: QUALCOMM Incorporated, San Diego, CA (US)

(72) Inventors: Kefeng ZHANG, Beijing (CN); Zhimin DU, Beijing (CN); Yan LI, Beijing (CN)

(21) Appl. No.: 18/562,136

(22) PCT Filed: Jul. 8, 2021
(86) PCT No.: PCT/CN2021/105131

§ 371 Date: Nov. 17, 2023

(51) Int. Cl. H04W 48/18; H04L 61/5046; H04W 8/20; H04W 48/16

(52) U.S. Cl. CPC H04W 48/18; H04L 61/5046; H04W 8/20; H04W 48/16

(57) ABSTRACT

Certain aspects of the present disclosure provide techniques for provisioning static internet protocol (IP) addresses or prefixes (referred collectively as “addresses” herein) by an application function (AF). For example, the AF may manage (e.g., request to update and/or allocate) static IP addresses for one or more user equipments (UEs), such as for a protocol data unit (PDU) session of a data network name (DNN) of a single-network slice selection assistance information (S-NSSAI).

### BACKGROUND

### Field of the Disclosure

Aspects of the present disclosure relate to wireless communications, and more particularly, to techniques for managing user equipment (UE) internet protocol (IP) addresses.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims, which follow, some features will now be discussed briefly. After considering this discussion, and particularly after reading the section entitled “Detailed Description” one will understand how the features of this disclosure provide advantages.

Certain aspects of the subject matter described in this disclosure can be implemented in a method for wireless communication by a first entity. The method generally includes providing information to a second entity in a request to update a relation between at least one user equipment (UE) identifier (ID) and at least one corresponding static internet protocol (IP) address for a protocol data unit (PDU) session to a data network name (DNN) of a single-network slice selection assistance information (S-NSSAI). The method further includes receiving a response indicating whether the request to update is granted from the second entity.

Certain aspects of the subject matter described in this disclosure can be implemented in a method for wireless communication by a second entity. The method generally includes receiving, from a first entity, a request to update a relation between at least one user equipment (UE) ID and at least one corresponding static UE internet protocol (IP) address for a protocol data unit (PDU) session, and requesting an update of subscription data based on the relation received in the request.

Certain aspects of the subject matter described in this disclosure can be implemented in an apparatus for wireless communications by a first entity. The apparatus includes a memory having executable instructions stored thereon; and a processor configured to execute the executable instructions to cause the apparatus to: provide information to a second entity in a request to update a relation between at least one user equipment (UE) identifier (ID) and at least one corresponding static internet protocol (IP) address for a protocol data unit (PDU) session to a data network name (DNN) of a single-network slice selection assistance information (S-NSSAI); and receive a response indicating whether the request to update is granted from the second entity.

Certain aspects of the subject matter described in this disclosure can be implemented in an apparatus for wireless communications by a second entity. The apparatus includes a memory having executable instructions stored thereon; and a processor configured to execute the executable instructions to cause the apparatus to: receive, from a first entity, a request to update a relation between at least one user equipment (UE) ID and at least one corresponding static UE internet protocol (IP) address for a protocol data unit (PDU) session, and request an update of subscription data based on the relation received in the request.

Aspects of the present disclosure provide means for, apparatus, processors, and computer-readable mediums for performing the methods described herein.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

The following description and the appended figures set forth certain features for purposes of illustration.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example a base station (BS) and user equipment (UE), in accordance with certain aspects of the present disclosure.

FIG. 3 is a block diagram illustrating an example architecture of a core network (CN) and radio access network (RAN), in accordance with certain aspects of the present disclosure.

FIG. 4 is a call flow diagram illustrating messages that may be exchanged between an application function (AF), a unified data management (UDM) module, and a system management function (SMF), in accordance with certain aspects of the present disclosure.

FIG. 5 is a call flow diagram illustrating messages that may be exchanged between an AF, a UDM module, a SMF, and a network data AF (NWDAF), in accordance with certain aspects of the present disclosure.

FIG. 6 illustrates example operations that may be performed by a first entity, in accordance with certain aspects of the present disclosure.

FIG. 7 illustrates example operations that may be performed by a second entity, in accordance with certain aspects of the present disclosure.

FIG. 8 is a call flow diagram illustrating an AF providing a list of static IP addresses to a group of UEs, in accordance with certain aspects of the present disclosure.

FIG. 9 illustrates example options for including parameters for the list of static IP addresses of FIG. 8, in accordance with certain aspects of the present disclosure.

FIG. 10 is a call flow diagram illustrating an AF providing static IP addresses for individual UEs, in accordance with certain aspects of the present disclosure.

FIGS. 11 and 12 illustrate communications devices that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for provisioning static internet protocol (IP) addresses or prefixes (referred collectively as “addresses” herein) by an application function (AF). For example, the AF may manage (e.g., request to update and/or allocate) static IP addresses for one or more user equipments (UEs), such as for a protocol data unit (PDU) session of a data network name (DNN) of a single-network slice selection assistance information (S-NSSAI).

Conventional static UE IP addresses are manually managed by mobile operators and stored in the unified data management (UDM) during PDU session establishment procedure. The session management function (SMF) would retrieve this static IP address from the UDM. The manual management of the static UE IP addresses may be achieved via operations, administrations, and maintenance (OAM). Such manual management, however, may not meet various requirements in emerging vertical industries. The present disclosure provides techniques for the AF to manage static IP addresses, such as to request updating the subscription information stored in the UDM or the unified data repository (UDR). In particular, the AF may manage the static UE IP addresses for a group of UEs, or for one or more individual UEs. The AF may avoid UE IP address conflict when allocating or requesting an allocation for the static UE IP addresses. The AF may also handle ongoing PDU sessions when the static UE IP addresses require updates.

The present disclosure provides several advantages or benefits over the OAM manual management. For example, conventional OAM management of static UE IP addresses in the subscription data may lack procedures for configuration. Various configuration procedures are disclosed herein to fill such blank. Furthermore, as demand for static IP addresses increases, the existing dynamic UE IP address allocation via dynamic host configuration protocol (DHCP) or data network authentication, authorization, and accounting (DN-AAA) may be insufficient. The present disclosure enables an AF to request a 5G system to allocate a set of permanent static IP addresses in one or more particular UEs or a group of UEs (e.g., in a 5G virtual network (VN)), thus meeting IP address management requirements in different vertical applications.

Very often, UEs use dynamic IP addresses. For example, enhanced mobile broadband (eMBB) communication services often allocate dynamic UE IP addresses (e.g., IPv4) and IP prefixes (e.g., IPv6) in UEs. By contrast, static IP addresses are preferred instead of dynamic IP addresses for vertical applications that are defined and built according to a user's specific requirements to meet specific needs. In such applications, permanent (i.e., static) IP addresses for UEs may facilitate the deployment and management of connected devices for vertical customers. For example, UEs such as file servers, printers, computers, vehicles may be allocated with static IP addresses to avoid issues caused by reconnection or system reboot.

In one example scenario, a 5G virtual network may provide service for private communications using IP or non-IP communications, replacing or emulating the existing wireless local area network (WLAN) or fixed local area network (LAN) of an enterprise. If dynamic IP addresses are allocated, each connection instance may assign a different IP address, resulting in network resource access complexity and reduced network stability. Static IP addresses avoids such complexity and instability. In another example scenario, wireless pairing between two devices, such as a vehicle and its controller, may benefit from knowing the static IP address (of each other). Other vertical applications scenarios may also benefit from static IP address allocations, such as in: smart home devices, video surveillance devices, video/audio production devices, smart factory devices, platooning vehicles, aerial vehicles, document servers, printers, IP cameras, etc.

The following description provides examples of AF providing information in a request to update static UE IP addresses. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies me. For clarity, while aspects may be described herein using terminology commonly associated with 3G, 4G, and/or new radio (e.g., 5G NR) wireless technologies, aspects of the present disclosure can be applied in other generation-based communication systems, including later technologies.

NR access may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QOS) requirements. In addition, these services may co-exist in the same subframe.

Certain wireless networks utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. The system bandwidth may also be partitioned into subbands.

5G NR may utilize OFDM with a cyclic prefix (CP) on the uplink and downlink and include support for half-duplex operation using time division duplexing (TDD). A subframe can be 1 ms, but the basic transmission time interval (TTI) may be referred to as a slot. A subframe contains a variable number of slots (e.g., 1, 2, 4, 8, 16, . . . slots) depending on the subcarrier spacing (SCS). The NR resource block (RB) may be 12 consecutive frequency subcarriers. NR may support a base SCS of 15 KHz and other subcarrier spacing may be defined with respect to the base SCS, for example, 30 kHz, 60 kHz, 120 kHz, 240 kHz, etc. The symbol and slot lengths scale with the SCS. The CP length also depends on the SCS. 5G NR may also support beamforming and beam direction may be dynamically configured. Multiple-input multiple-output (MIMO) transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

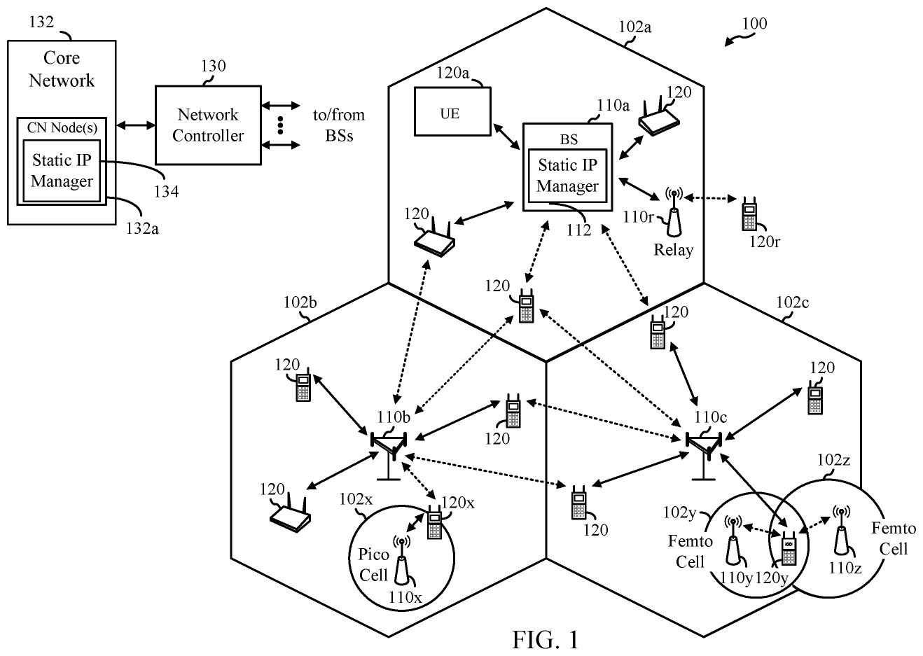

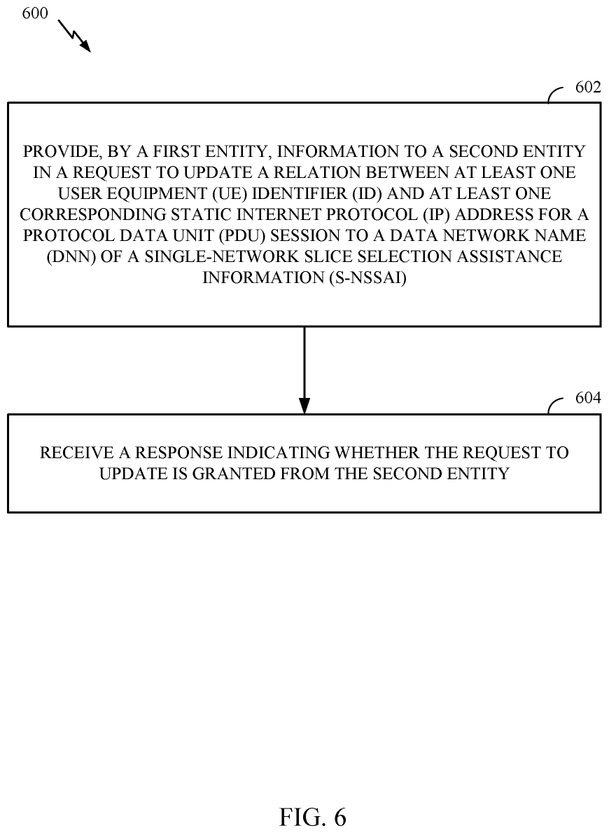

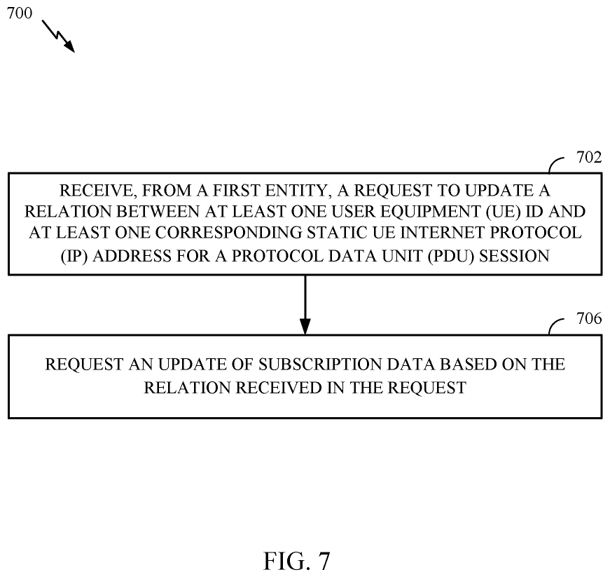

FIG. 1 illustrates an example wireless communication network 100 in which aspects of the present disclosure may be performed. For example, the wireless communication network 100 may include one or more base stations (BSs) 110, each including a corresponding static IP manager 112. The wireless communication network 110 may further include one or more core network nodes 132, each including a static IP manager 134. The static IP managers 112 and 134 may perform one or more operations for updating static IP addresses disclosed herein, such as operations 600 and 700 shown in FIGS. 6 and 7.

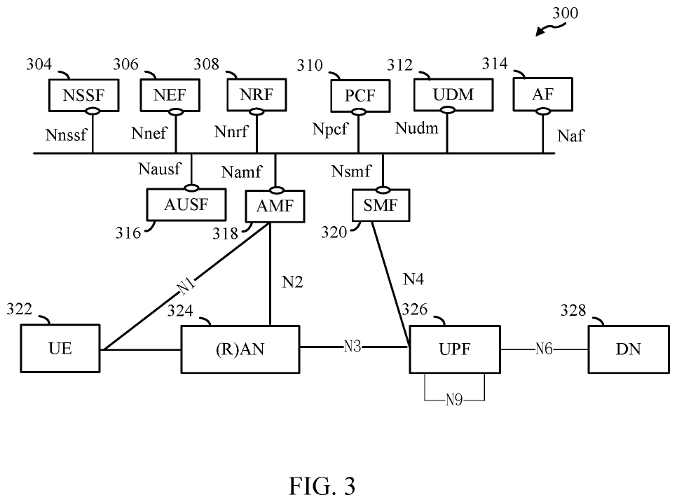

The wireless communication network 100 may be an NR system (e.g., a 5G NR network). As shown in FIG. 1, the wireless communication network 100 may be in communication with a core network 132. The core network 132 may in communication with one or more BSs 110 and/or UEs 120 via one or more interfaces as discussed more detail below with respect to FIG. 3.

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

The wireless communication network 100 may be in communication with the CN 132, which includes one or more CN nodes 132a. A network controller 130 may couple to a set of BSs 110 and provide coordination and control for these BSs 110. The network controller 130 may communicate with the BSs 110 via a backhaul. The network controller 130 may also couple to one or more of the CN nodes 132a.

According to certain aspects, the BSs 110 and core network 132 may be configured to manage network slices assigned to a UE such that compatibility is ensured between network slice operating frequencies and the radio capabilities of the UEs 120 in wireless communication network 100. As shown in FIG. 1, the BS 110a includes a static IP manager 112. The static IP manager 112 may be configured to exchange information with a network core entity (e.g., a core network node 132) to manage one or more static UE IP addresses for one or more individual UEs or a group of UEs, in accordance with aspects of the present disclosure. As shown in FIG. 1, the core network nodes 132a include a static IP manager 134. The static IP manager 134 may be configured to exchange information with a network entity (e.g., a BS 110) to manage one or more static UE IP addresses for one or more individual UEs or a group of UEs, in accordance with aspects of the present disclosure.

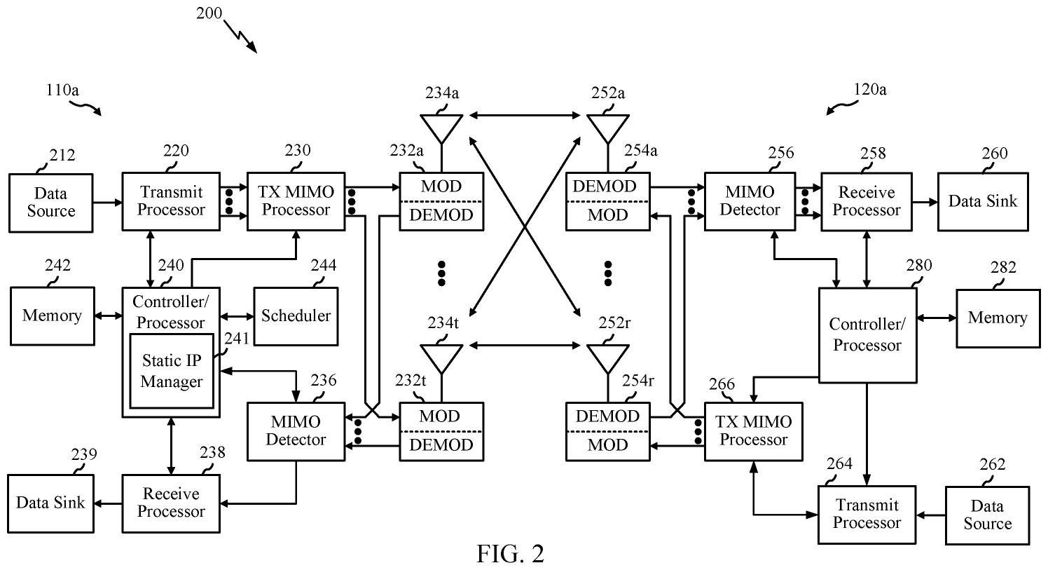

FIG. 2 illustrates example components of BS 110a and UE 120a (e.g., in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. For example, a base station may transmit a MAC CE to a UE to put the UE into a discontinuous reception (DRX) mode to reduce the UE's power consumption. The MAC-CE may be carried in a shared channel such as a physical downlink shared channel (PDSCH), a physical uplink shared channel (PUSCH), or a physical sidelink shared channel. A MAC-CE may also be used to communicate information that facilitates communication, such as information regarding buffer status and available power headroom.

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

The controller/processor 280 and/or other processors and modules at the UE 120a may perform or direct the execution of processes for the techniques described herein. For example, as shown in FIG. 2, the controller/processor 240 of the BS 110a has a static IP manager 241 that may be configured to manage static UE IP addresses, according to aspects described herein. Although shown at the controller/processor, other components of the UE 120a and BS 110a may be used to perform the operations described herein.

FIG. 3 is a block diagram illustrating an example architecture of a core network (CN) 300 (e.g., such as the CN 132 in FIG. 1) in communication with a RAN 324, in accordance with certain aspects of the present disclosure. As shown in FIG. 3, the example architecture includes the CN 300, RAN 324, UE 322, and data network (DN) 328 (e.g. operator services, Internet access or third party services).

The CN 300 may host core network functions. CN 300 may be centrally deployed. CN 300 functionality may be offloaded (e.g., to advanced wireless services (AWS)), in an effort to handle peak capacity. As shown in FIG. 3, the example CN 300 may be implemented by one or more network entities that perform network functions (NF) including Network Slice Selection Function (NSSF) 304, Network Exposure Function (NEF) 306, NF Repository Function (NRF) 308, Policy Control Function (PCF) 310, Unified Data Management (UDM) 312, Application Function (AF) 314, Authentication Server Function (AUSF) 316, Access and Mobility Management Function (AMF) 318, Session Management Function (SMF) 320; User Plane Function (UPF) 326, and various other functions (not shown) such as Unstructured Data Storage Function (UDSF); Unified Data Repository (UDR); 5G-Equipment Identity Register (5G-EIR); and/or Security Edge Protection Proxy (SEPP).

The AMF 318 may include the following functionality (some or all of the AMF functionalities may be supported in one or more instances of an AMF): termination of RAN control plane (CP) interface (N2); termination of non-access stratum (NAS) (e.g., N1), NAS ciphering and integrity protection; registration management; connection management; reachability management; mobility management; lawful intercept (for AMF events and interface to L1 system); transport for session management (SM) messages between UE 322 and SMF 320; transparent proxy for routing SM messages; access authentication; access authorization; transport for short message service (SMS) messages between UE 322 and a SMS function (SMSF); Security Anchor Functionality (SEAF); Security Context Management (SCM), which receives a key from the SEAF that it uses to derive access-network specific keys; Location Services management for regulatory services; transport for Location Services messages between UE 322 and a location management function (LMF) as well as between RAN 324 and LMF; evolved packet service (EPS) bearer ID allocation for interworking with EPS; and/or UE mobility event notification; and/or other functionality.

SMF 320 may support: session management (e.g., session establishment, modification, and release), UE IP address allocation and management, dynamic host configuration protocol (DHCP) functions, termination of NAS signaling related to session management, downlink data notification, and traffic steering configuration for UPF for proper traffic routing. UPF 326 may support: packet routing and forwarding, packet inspection, quality-of-service (QOS) handling, external protocol data unit (PDU) session point of interconnect to DN 328, and anchor point for intra-RAT and inter-RAT mobility. PCF 310 may support: unified policy framework, providing policy rules to control protocol functions, and/or access subscription information for policy decisions in UDR. AUSF 316 may acts as an authentication server. UDM 312 may support: generation of Authentication and Key Agreement (AKA) credentials, user identification handling, access authorization, and subscription management. NRF 308 may support: service discovery function, and maintain NF profile and available NF instances. NSSF may support: selecting of the Network Slice instances to serve the UE 322, determining the allowed network slice selection assistance information (NSSAI), and/or determining the AMF set to be used to serve the UE 322.

NEF 306 may support: exposure of capabilities and events, secure provision of information from external application to 3GPP network, translation of internal/external information. AF 314 may support: application influence on traffic routing, accessing NEF 306, and/or interaction with policy framework for policy control.

As shown in FIG. 3, the CN 300 may be in communication with the AS 302, UE 322, RAN 324, and DN 328. In some examples, the CN 300 communicates with the external AS 302 via the NEF 306 and/or AF 314. In some examples, the CN 300 communicates with the RAN 324 (e.g., such as the BS 110a in the wireless communication network 100 illustrated in FIG. 1) and/or the UE 322 (e.g., such as the UE 120a in the wireless communication network 100 illustrated in FIG. 1) via the AMF 318.

The NSSF 304 supports the following functionality: selecting of the network slice instances to serve the UE 322; determining the allowed network slice selection assistance information (NSSAI); and/or determining the AMF set to be used to serve the UE 322.

A network slice may be defined as a logical network that provides specific network capabilities and network characteristics. A network slice instance may be defined as a set of network function instances and the required resources (e.g., compute, storage, and networking resources) which form a deployed network slice.

A network slice is identified by single network slice selection assistance information (S-NSSAI). NSSAI is a list of one or more S-NSSAIs. An S-NSSAI includes a slice/service type (SST), which refers to the expected network slice behavior (e.g., features and services), and a slice differentiator (SD), which is optional information that complements the SST(s) to differentiate amongst multiple network slices of the same SST. An S-NSSAI can have standard values (e.g., including an SST with a standardized SST value and no SD) or non-standard values (e.g., including an SST and an SD or including an SST without a standardized SST value and no SD). An S-NSSAI with a non-standard value identifies a single network slice within the PLMN with which it is associated. An S-NSSAI with a non-standard value may not be used by the UE in access stratum procedures in any PLMN other than the one to which the S-NSSAI is associated.

Network slices may differ with respects to supported features and network functions optimizations. For example, different S-NSSAIs may have different SSTs. An operator can deploy multiple network slice instances delivering the same features, but for different groups of UEs (e.g., dedicated to a customer different S-NSSAIs with the same SST but different SDs). The network may serve a single UE with one or more network slice instances simultaneously (e.g., via the 5G-AN). In some examples, a UE may be associated with up to eight different S-NSSAIs in total.

AMF instances can be common to network slice instances serving a UE. Selection of the set of network slice instances for a UE is triggered by the first contacted AMF in a registration procedure normally by interacting with the NSSF. A PDU session may belong to one specific network slice instance per PLMN. Different network slice instances may not share a protocol data unit (PDU) session, though different slices may have slice-specific PDU sessions using the same data network name (DNN). In order to enable PDU transmission in a network slice, the UE may request establishment of a PDU session in a network slice towards a DN associated with an S-NSSAI and a (DNN if there is no established PDU session adequate for the PDU transmission. The S-NSSAI included is part of allowed NSSAI of the serving PLMN, which is an S-NSSAI value valid in the serving PLMN, and in roaming scenarios the mapped S-NSSAI is also included for the PDU session if available.

### General Management of UE ID and IP Address

Aspects of the present disclosure provide techniques for managing static user equipment (UE) Internet protocol (IP) addresses (including prefixes) from an application function (AF). For example, the AF may provide information to a network exposure function (NEF) or a unified data management (UDM) in a request to update a relation between at least one UE identifier (ID) and at least one corresponding static IP address for a protocol data unit (PDU) session to a data network name (DNN) of a single-network slice selection assistance information (S-NSSAI). The update may be applicable to general management of UE ID and IP addresses, as discussed below.

In certain UE data collection procedures, an entity (e.g., AF, NEF, UDM, etc.) may need to acquire a UE ID (e.g., a subscription permanent identifier (SUPI) and/or a generic public subscription identifier (GPSI)) and a UE IP address mapping relation. The entity may need to store information regarding this mapping relation locally or send it to another entity for storage. The relation between the UE ID and IP address generally provides an association between a UE and an IP network. For example, the association may be identified by a UE represented by an Ipv4 address and/or an Ipv6 prefix (generally referred to as “IP addresses”) together with a UE ID. A PDU session associated with the UE may exists as long as the related UE Ipv4 address and/or Ipv6 prefix are established and announced to the IP network.

In some examples, an application function (AF) or a Network Data Analytics Function (NWDAF) may perform this mapping procedure. An AF may indicate mapping capability in a network function (NF) profile and register with a network repository function (NRF) if it supports performing the mapping itself, or, instead, it may request for the NWDAF to perform the mapping. When an AF supports the mapping, the AF may correlate the UE IP address and UE ID. When the AF does not support the mapping, the NWDAF may instead correlate the UE IP address and UE ID and/or provide the information necessary to perform such correlation.

In some cases, a session management event exposure service may be provided by a Session Management Function (SMF). This service allows consumer NFs to subscribe and unsubscribe for events related to a PDU session. Furthermore, the service notifies consumer NFs with a corresponding subscription about observed events on the PDU session. The types of observed events may include a user plane function (UPF) change (e.g., addition and/or removal of PDU session anchor); a SMF change; application traffic detection (e.g., start and stop); PDU session statistics (e.g., usage reporting); a PDU session release; and/or an out of credit indication.

The PDU Session Release procedure is generally used to release all the resources associated with a PDU Session. These resources may include the IP address/Prefixes allocated for an IP-based PDU Session, any UPF resource that was used by the PDU Session, and any access resource that was used by the PDU Session. The SMF typically notifies any entity associated with PDU Session, and any entity that has successfully subscribed for notification, of a PDU Session Release.

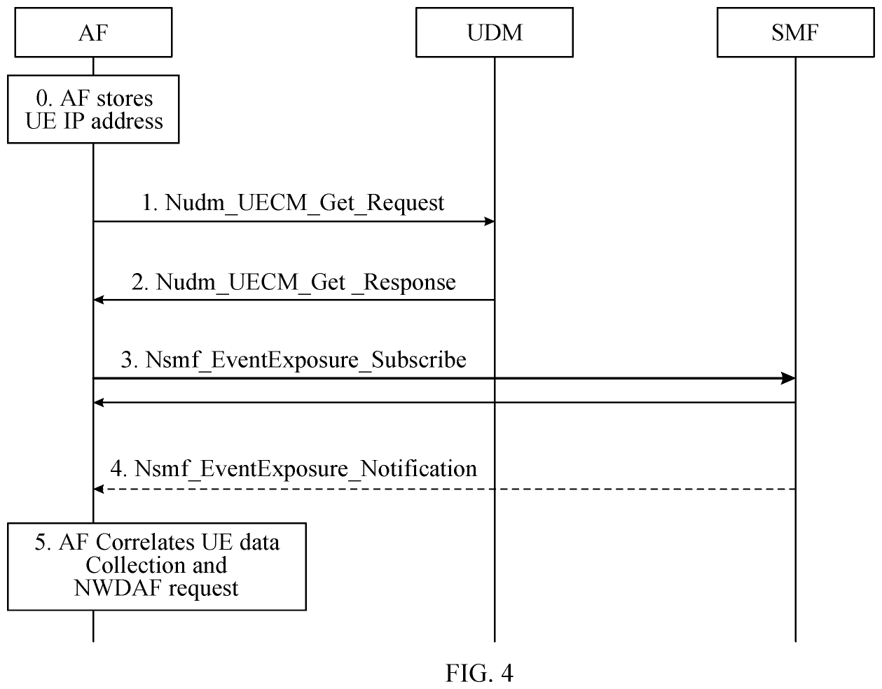

FIG. 4 is a call flow diagram illustrating messages that may be exchanged between an AF, a unified data management (UDM) module, and a SMF, in accordance with certain aspects of the present disclosure. As shown, at step 0, at the establishment of a user plane connection between the UE Application and the AF, the AF may store the UE IP address (e.g., for both direct and indirect reporting). The UDM module or network function may provide authentication and subscription information to a core network (CN) function that controls network access and operates to establish a subscriber session. The UDM module may also manage existing sessions of current subscribers dynamically, and provide session information to UEs on request.

At step 1, the AF may receive a request to retrieve input data, for example, including a SUPI. At this step, the AF may find the SMF serving the PDU session(s) for this SUPI using a request (e.g., a Nudm_UECM_Get_Request) including the SUPI, the type of requested information set to SMF registration info, the single network slice selection assistance information (S-NSSAI), and data network name (DNN). For example, a value of Nudm_UECM indicates a UE Context Management service that manages UE's current session. Nudm_UECM is associated with network functions that serve the UE to register with the UDM. As shown in FIG. 4, the Nudm_UECM_Get_Request (current step) indicates a request from the context management service and the Nudm_UECM_Response (next step) indicates a corresponding response.

At step 2, the UDM provides the SMF ID and the corresponding PDU Session ID (e.g., S-NSSAI and DNN), by sending the Nudm_UECM_Get_Response to the AF. In this regard, the AF determines the UE activated PDU session that the S-NSSAI and DNN supported by the AF is served for on the user plane connection between the UE and the AF. At step 3, the AF sends a message (e.g., the Nsmf_EventExposure_Subscribe message) to the SMF identified in step 2, including the Target for Event Reporting set to the PDU Session ID(s) provided in step 2 and the Event ID set to IP address/prefix allocation/change. For example, the Nsmf_EventExposure_Subscribe service operation may be used by an NF service consumer to subscribe for event notifications on a specified PDU session, or for all PDU sessions of one UE, group of UE(s) or any UE, or to modify an existing subscription.

At step 4, the SMF provides (e.g., sent via a notification, such as the Nsmf_EventExposure_Notification as shown) the allocated IPv4 address and/or IPv6 prefix, per the PDU Session ID, to the AF. At step 5, the AF correlates the UE data that includes the UE IP address and the NWDAF request for a SUPI using the retrieved IPv4 address and/or IP v6 prefix (e.g., and stores this information locally). As noted above, in case the AF does not support the mapping, the NWDAF may instead correlate the UE IP address and UE ID and/or provide the information necessary to perform such correlation.

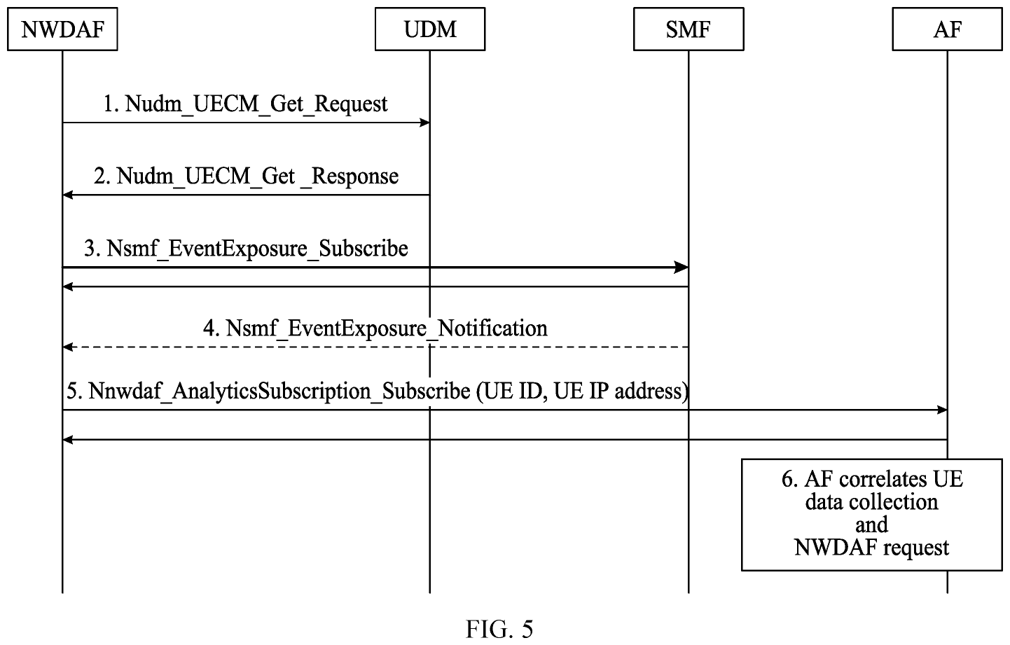

FIG. 5 is a call flow diagram illustrating messages that may be exchanged between an AF, a UDM module, a SMF, and a network data AF NWDAF, in accordance with certain aspects of the present disclosure. As shown, the call flow diagram of FIG. 5 is generally similar to that of FIG. 4, with the main difference being the NWDAF functions as the consumer (instead of the AF) to perform step 1 through 5. In this regard, after the NWDAF collects the UE ID and UE IP address mapping information, the NWDAF sends the mapping information to the AF for storage.

### Example Application Function (AF) Provisioning Static IP Addresses

FIG. 6 illustrates example operations 600 that may be performed by a first entity (e.g., an AF) to provide information in a request to update static UE IP addresses, in accordance with certain aspects of the present disclosure. The operations 600 may be performed by the static IP manager 134 and/or the static IP manager 112 of FIG. 1, or the AF 314 of the CN 300 of FIG. 3.

Operations 600 may begin, at 602, by providing information to a second entity in a request to update a relation between at least one UE ID and at least one corresponding static IP address for a protocol data unit (PDU) session to a data network name (DNN) of a single-network slice selection assistance information (S-NSSAI). For example, the first entity is the AF and the request may be transmitted to a network exposure function (NEF) or directly to a unified data management (UDM) to update subscription data, which includes data in each DNN S-NSSAI level. As such, a same UE may be assigned with one or more IP addresses (including the static IP address) in corresponding levels of DNN S-NSSAI.

In aspects, the first entity provides information that includes an external group ID for a group of UEs, such as UEs in a 5G virtual network (VN) group membership management. The information includes a list of generic public subscription identifiers (GPSIs) for one or more members of the group of UEs. In some cases, the at least one corresponding static IP address includes a list of static IP addresses and corresponding IP versions for one or more members of the group of UEs. In aspects, the AF provides information that includes one or more GPSIs for one or more particular UEs to be configured with static IP addresses.

In aspects, the information in the request to update may include instructions to create, update, or delete at least one of group subscription data or UE subscription data in a unified data repository (UDR).

In aspects, the first entity may allocate the corresponding static IP addresses in the request. When the IP addresses are not for a group of UEs, the first entity may further avoid conflicting address allocations when allocating the corresponding static IP addresses. The first entity may also request a network entity to allocate the static IP addresses. For example, the first entity may transmit an allocation request with the GPSIs for one or more UEs or a list of group UEs to a network entity. Upon receiving the static IP addresses from the network entity in response to the allocation request, the first entity may store a mapping table of the relation.

At 604, the first entity receives a response indicating whether the request to update is granted from the second entity. For example, the NEF or UDM may transmit the response to the AF, regarding the update to the subscription data.

FIG. 7 illustrates example operations 700 that may be performed by a second entity (e.g., a UDM) to update storage of group or particular UE subscription data, in accordance with certain aspects of the present disclosure. Operations 700 may be performed in complementary or in response to the operations 600 of FIG. 6. The operations 700 may also be performed by the static IP manager 134 and/or the static IP manager 112 of FIG. 1, or the UDM 312 of the CN 300 of FIG. 3.

Operations 700 may begin, at 702, by receiving, from a first entity, a request to update a relation between at least one UE ID and at least one corresponding static UE IP address for a PDU session. The PDU session may be for a DNN S-NSSAI level. At 702, the second entity may request an update of subscription data based on the relation received in the request.

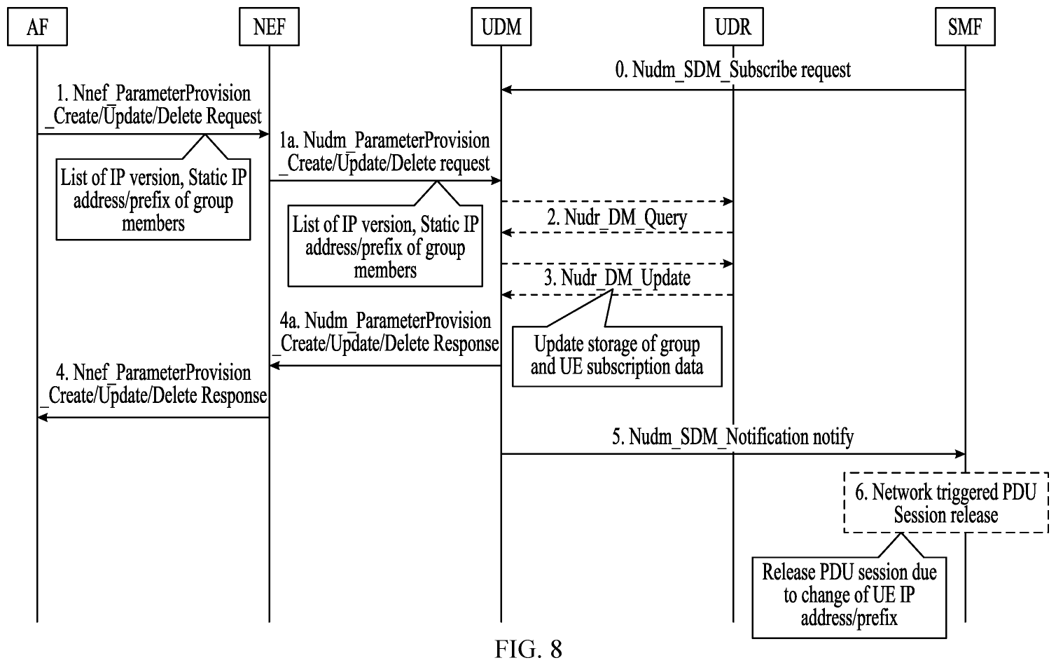

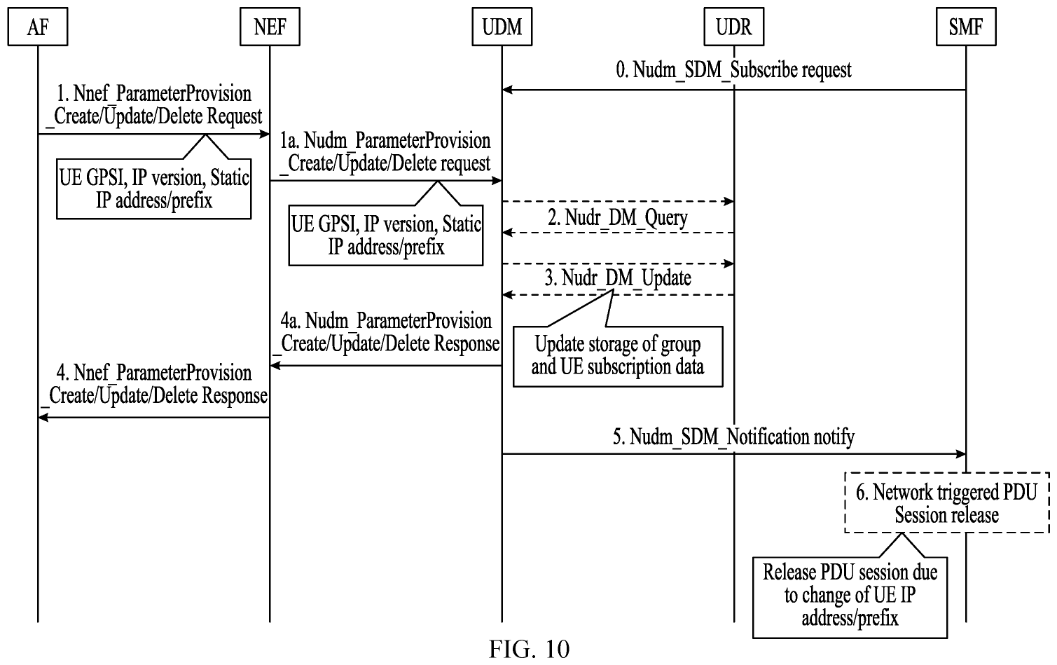

Operations 600 and 700 of FIGS. 6 and 7 may be understood with reference to the call flow diagrams shown in FIGS. 8 and 10. For example, FIGS. 8 and 10 respectively illustrate two options for performing the operations 600 and 700. In a first option, as shown in FIG. 8, the static IP addresses are configured for a group of UEs, such as UEs in a virtual network (e.g., 5G VN) or other 5G services with UE group management capabilities. In a second option, as shown in FIG. 10, the static IP addresses are configured for one or more individual UEs that may face conflicting IP address allocations.

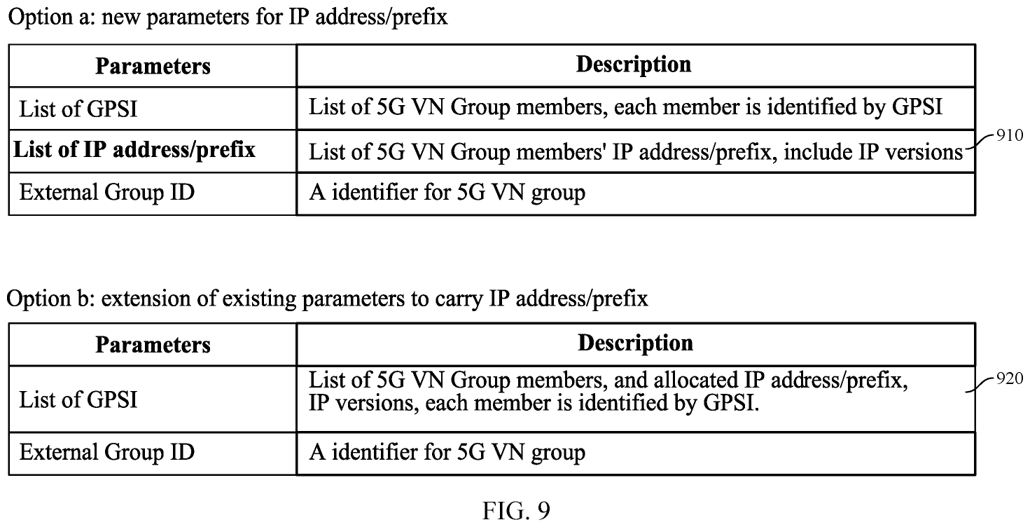

FIG. 8 is a call flow diagram illustrating an AF providing a list of static IP addresses to a group of UEs, in accordance with certain aspects of the present disclosure. As shown, the AF may provide information for a list of static IP addresses (including prefix when applicable), IP versions, for a group of UE members. For example, the call flow of FIG. 8 may be applied for 5G VN and other 5G services with UE group management capabilities. As such, the AF is enabled to request static IP address and/or prefix configurations for a group of UEs in a single request, which inherently avoids allocation conflicts. Furthermore, existing 5G VN group membership management procedures may be reused, with extension on the carried parameters (an example shown in FIG. 9).

At step 1 as shown, the AF may provide the expected static IP address and/or prefix of each UE in the message of group membership management request. The AF provides group membership management parameters to the NEF, which includes the list of IP version and static IP address/prefix of group members. The request may ask for an update, including creating, updating an existing, and/or deleting one or more static IP addresses. The request may include one or more of the following parameters (indicated by “N” as shown): an external group ID, a list of GPSI of each membership UEs, a list of static IP addresses, and an IP version of each membership UE.

As shown, the AF sends the request to the NEF, which, at step 1a, validates the authorization of the request, then forward the parameters to UDM. In a different implementation, however, the AF may send the request directly to the UDM (i.e., not via NEF). For example, when the AF is deployed in the trusted domain of the mobile operator, AF may be authorized to communicate with UDM directly via the Nudm interface. The NEF is not involved in this procedure.

The UDM may, prior to AF sending the request, receive a subscription request from the session management function (SMF). Upon receiving the list of IP versions and the static IP addresses from the NEF, the UDM may communicate with the unified data repository (UDR). At steps 2 and 3, the UDM may authorize the request, resolves the SUPI of each GPSI and requests to create, update or delete the group subscription data and UE subscription data in the UDR. At step 3, the UDM and UDR may update the storage of group and UE subscription data based on the received information. If the UDM authorizes the request, the UDM will request to create, update or delete the group subscription data and UE subscription data in the UDR (e.g., IP version and static IP address/prefix).

Upon successful updating the subscription data, the UDM, at step 4a, sends a response to the NEF, which relays the response at step 4 to the AF, about the subscription data update. At step 5, the UDM may further notify the SMF regarding the subscription data update with the static IP addresses. For example, upon receiving the static IP address/prefix change from UDM via Nudm_SDM_Notification (e.g., via a Nudm subscriber data management service), SMF may trigger the release of existing PDU Sessions of the membership UEs due to UE IP address change. The PDU session can be re-established with the updated UE IP address. At step 6, the network may respond to the update and trigger a PDU session release due to the change of UE IP addresses. The AF allocated static IP address of group memberships may be removed by UDM/UDR when the group is deleted via Nudm_ParameterProvision_Delete (e.g., defined in a Nudm_ParameterProvision service application programming interface).

FIG. 9 illustrates example options for including parameters for the list of static IP addresses of FIG. 8, in accordance with certain aspects of the present disclosure. In a first option (Option a as shown), new parameters for the static IP addresses may be added to the 5G VN group membership management parameters. For example, the parameters 910 may include a list of 5G VN group member's IP addresses, including IP versions, in addition to the list of GPSI and eternal group ID. In a second option (Option b as shown), existing parameters may be extended to carry the static IP addresses. For example, the list of GPSI may further include parameters 920 of allocated IP addresses and IP versions.

FIG. 10 is a call flow diagram illustrating an AF providing static IP addresses for individual UEs, in accordance with certain aspects of the present disclosure. As shown, the AF may provide information of static IP addresses (including prefix when applicable), IP versions, for one or more individual UEs. The static UE IP addresses may be allocated by the AF or the network. For example, the AF may send a request to create, update, or delete the static IP address/prefix of one or multiple UEs. In some cases, a new type of payload for external parameter provisioning may be defined. Such payload may be referred to as a UE static IP address/prefix parameter. Different options may be used to define this parameter.

For example, in one option, the AF allocates the static IP addresses and sends the static IP addresses for the UE in a request message. The AF may be a third party AF, which may have negotiated with mobile operator for the allocation of a pre-defined IP address pool to avoid IP address conflict. In another option, the AF may request the core network to allocate the static IP addresses for the UE. The allocated IP addresses are sent to the AF in a response message. The AF may then store and maintain a mapping table of the allocated IP addresses.

As shown in FIG. 10, the AF may provide information in a request to the NEF or UDM to update the UE subscription data. At step 1, the AF sends the UE GPSI, IP version, and the allocated static IP address to the NEF. At step 1a, the NEF forwards the request information to the UDM. In some cases, the AF may send the information directly to the UDM, similar to situations discussed in FIG. 8.

When the UDM authorizes the request from the AF, at steps 2 and 3, the UDM may request to create, update or delete the UE subscription parameters in the UDR based on the static IP addresses. At steps 4a and 4, the UDM provides responses to the NEF or AF regarding the subscription update. The UDM may then, at step 5, notify the SMF about the change of UE static IP addresses, for example, via a Nudm_SDM_Notification. For example, the UDM notifies the SMF of the change of SM subscriber data (static UE IP addresses). If the SMF identifies the existing PDU session is affected by the changes, the SMF triggers the release of the PDU session with cause. The cause may indicate a trigger to UE to establish a new PDU Session with the same characteristics, and NW (SMF/UDM) will allocate the new IP address to the UE. The PDU session can be re-established with the updated UE IP address. In some cases, online or offline coordination between the third party AF and the core network is needed to avoid IP address conflicts, for example, partition of IP address pool for specific AF.

In some cases, along with or in addition to the operations 600 and 700 performed (and illustrated in FIGS. 8 and 10), static IP addresses for UEs may be configured via OAM. For example, an external party may provide the configuration request and/or an IP address mapping table to the basic service set (BSS) or the operations support systems (OSS) of the mobile operator. The mobile operator may then accordingly update the corresponding subscription information of the UEs.

### Example Communications Devices

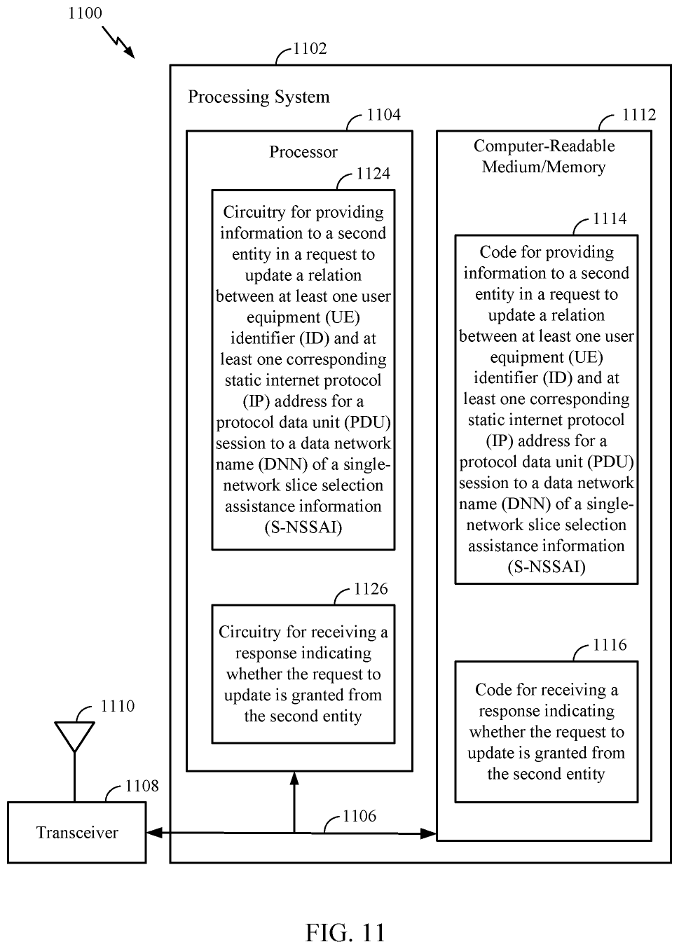

FIG. 11 illustrates a communications device 1100 that may include various components (e.g., corresponding to means-plus-function components) configured to perform operations for the techniques disclosed herein, such as the operations illustrated in FIG. 6. The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIG. 6, or other operations for performing the various techniques discussed herein for ensuring compatibility between network slice operating frequencies and UE radio capabilities. In certain aspects, computer-readable medium/memory 1112 stores code 1114 for providing information to a second entity in a request to update a relation between at least one user equipment (UE) identifier (ID) and at least one corresponding static internet protocol (IP) address for a protocol data unit (PDU) session to a data network name (DNN) of a single-network slice selection assistance information (S-NSSAI); and code 1116 for receiving a response indicating whether the request to update is granted from the second entity.

In certain aspects, the processor 1104 has circuitry configured to implement the code stored in the computer-readable medium/memory 1112. The processor 1104 includes circuitry 1124 providing information to a second entity in a request to update a relation between at least one user equipment (UE) identifier (ID) and at least one corresponding static internet protocol (IP) address for a protocol data unit (PDU) session to a data network name (DNN) of a single-network slice selection assistance information (S-NSSAI); and circuitry 1126 for receiving a response indicating whether the request to update is granted from the second entity.

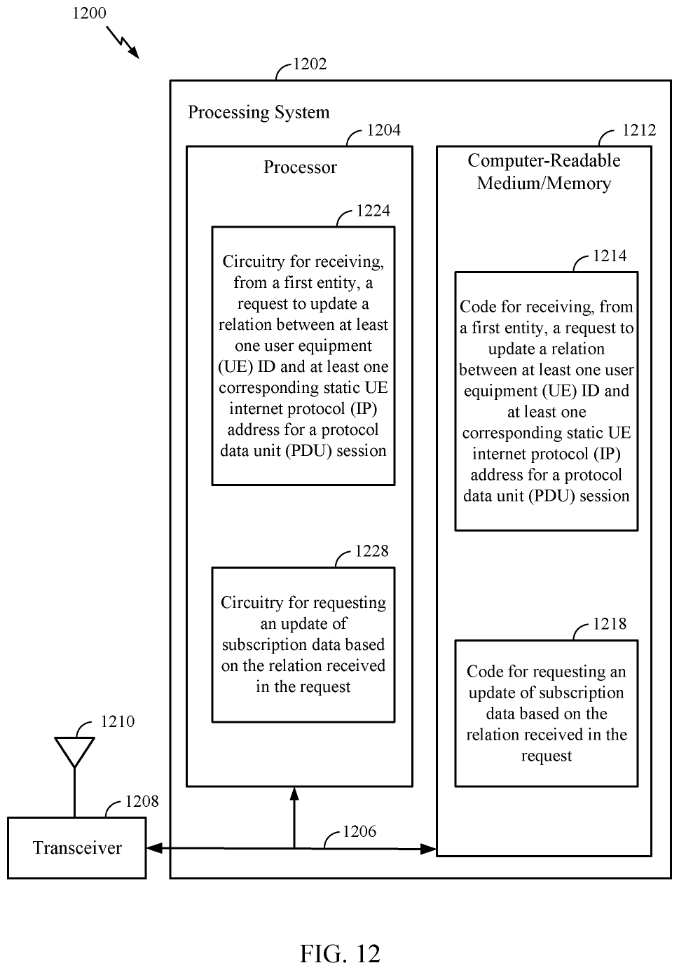

FIG. 12 illustrates a communications device 1200 that may include various components (e.g., corresponding to means-plus-function components) configured to perform operations for the techniques disclosed herein, such as the operations illustrated in FIG. 7. The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIG. 7, or other operations for performing the various techniques discussed herein for ensuring compatibility between network slice operating frequencies and UE radio capabilities. In certain aspects, computer-readable medium/memory 1212 stores code 1214 for receiving, from a first entity, a request to update a relation between at least one user equipment (UE) ID and at least one corresponding static UE internet protocol (IP) address for a protocol data unit (PDU) session; and code 1218 for requesting an update of subscription data based on the relation received in the request.

In certain aspects, the processor 1204 has circuitry configured to implement the code stored in the computer-readable medium/memory 1212. The processor 1204 includes circuitry 1224 for receiving, from a first entity, a request to update a relation between at least one user equipment (UE) ID and at least one corresponding static UE internet protocol (IP) address for a protocol data unit (PDU) session; and circuitry 1228 for requesting an update of subscription data based on the relation received in the request.

### Example Aspects

Aspect 1: A method for wireless communications by a first entity, comprising: providing information to a second entity in a request to update a relation between at least one user equipment (UE) identifier (ID) and at least one corresponding static internet protocol (IP) address for a protocol data unit (PDU) session to a data network name (DNN) of a single-network slice selection assistance information (S-NSSAI); and receiving a response indicating whether the request to update is granted from the second entity.

Aspect 2: The method of Aspect 1, wherein the first entity comprises an application function (AF).

Aspect 3: The method of Aspect 1 or 2, wherein the information comprises an external group ID for a group of UEs, and a list of generic public subscription identifiers (GPSIs) for one or more members of the group of UEs.

Aspect 4: The method of Aspect 3, wherein the at least one corresponding static IP address comprises a list of static IP addresses and corresponding IP versions for one or more members of the group of UEs.

Aspect 5: The method of Aspect 3, wherein the information in the request to update comprises instructions to create, update, or delete at least one of group subscription data or UE subscription data in a unified data repository (UDR).

Aspect 6: The method of any one of Aspects 1 to 5, wherein the second entity comprises a network exposure function (NEF) or a unified data management (UDM).

Aspect 7: The method of any one of Aspects 1 to 6, wherein the information comprises one or more generic public subscription identifiers (GPSIs) for one or more particular UEs to be configured with static IP addresses.

Aspect 8: The method of Aspect 6, further comprising allocating the corresponding static IP addresses in the request.

Aspect 9: The method of Aspect 8, wherein allocating the corresponding static IP addresses comprises avoiding conflicting address allocations.

Aspect 10: The method of Aspect 6, further comprising transmitting an allocation request with the GPSIs for the one or more particular UEs to a network entity, and receiving one or more static IP addresses from the network entity in response to the allocation request.

Aspect 11: The method of Aspect 10, further comprising: storing a mapping table of the relation, the mapping table mapping the GPSIs to the one or more static IP addresses allocated by the network entity.

Aspect 12: An method for wireless communications by a second entity, comprising: receiving, from a first entity, a request to update a relation between at least one user equipment (UE) ID and at least one corresponding static UE internet protocol (IP) address for a protocol data unit (PDU) session, and requesting an update of subscription data based on the relation received in the request.

Aspect 13: The method of Aspect 12, further comprising: receiving a data management query from a third entity; and transmitting the update of subscription data in response to the data management query to the third entity.

Aspect 14: The method of Aspect 13, wherein the third entity comprises a unified data repository (UDR).

Aspect 15: The method of any one of Aspects 12 to 14, further comprising: transmitting, a response regarding the request to update the relation, to the first entity that the update of subscription data based on the relation has been submitted.

Aspect 16: The method of any one of Aspects 12 to 15, further comprising: transmitting, a notification to a session management function (SMF), that the update of subscription data based on the relation has been submitted, wherein the notification triggers a release of a previous PDU session in response to the update of subscription data.

Aspect 17: The method of Aspect 16, wherein the SMF identifies, in the notification, Subscription Permanent Identifier (SUPI), and the session management subscriber data to be updated.

Aspect 18: The method of any one of Aspects 12 to 17, wherein the request comprises an external group ID for a group of UEs, and a list of generic public subscription identifiers (GPSIs) for one or more members of the group of UEs.

Aspect 19: The method of Aspect 18, wherein the at least one corresponding static IP address comprises a list of static IP addresses and corresponding IP versions for one or more members of the group of UEs.

Aspect 20: The method of Aspect 18, wherein the request to update comprises instructions to create, update, or delete at least one of group subscription data or UE subscription data.

Aspect 21: The method of any one of Aspects 12 to 20, wherein the first entity comprises a network exposure function (NEF) and the second entity comprises a unified data management (UDM), the NEF receiving the relation from an application function (AF).

Aspect 22: The method of any one of Aspects 12 to 20, wherein the first entity comprises an application function (AF) and the second entity comprises a unified data management (UDM).

Aspect 23: The method of any one of Aspects 12 to 17, wherein the request comprises one or more generic public subscription identifiers (GPSIs) for one or more particular UEs to be configured with static IP addresses.

Aspect 24: The method of Aspect 23, wherein the at least one corresponding static IP addresses in the request are allocated by the first entity.

Aspect 25: The method of Aspect 24, wherein the allocation of the at least one corresponding static IP addresses avoids conflicting address allocations.

Aspect 26: The method of Aspect 23, wherein at least one corresponding static IP addresses in the request are allocated by a network entity in response to requests by the first entity, wherein the relation is stored in a mapping table at the first entity, the mapping table mapping the GPSIs to the at least one corresponding static IP addresses allocated by the network entity.

Aspect 27: An apparatus for wireless communications by a first entity, comprising: a memory having executable instructions stored thereon; and a processor configured to execute the executable instructions to cause the apparatus to: provide information to a second entity in a request to update a relation between at least one user equipment (UE) identifier (ID) and at least one corresponding static internet protocol (IP) address for a protocol data unit (PDU) session to a data network name (DNN) of a single-network slice selection assistance information (S-NSSAI); and receive a response indicating whether the request to update is granted from the second entity.

Aspect 28: The apparatus of Aspect 27, wherein the first entity comprises an application function (AF).

Aspect 29: An apparatus for wireless communications by a second entity, comprising: a memory having executable instructions stored thereon; and a processor configured to execute the executable instructions to cause the apparatus to: receive, from a first entity, a request to update a relation between at least one user equipment (UE) ID and at least one corresponding static UE internet protocol (IP) address for a protocol data unit (PDU) session, and request an update of subscription data based on the relation received in the request.

Aspect 30: The apparatus of Aspect 29, wherein the first entity comprises an application function (AF) and the second entity comprises a unified data management (UDM).

Aspect 31: An apparatus for wireless communications by a first entity, comprising: means for performing the method of any one of Aspects 1-26.

Aspect 32: A computer-readable medium having instructions stored thereon which, when executed by a processor, performs the method of any one of claims 1-26.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IOT) devices, which may be narrowband IoT (NB-IOT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a UE 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 6 and/or FIG. 7.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a first entity, comprising:
providing information to a second entity in a request to update a relation between at least one user equipment (UE) identifier (ID) and at least one corresponding static internet protocol (IP) address for a protocol data unit (PDU) session to a data network name (DNN) of a single-network slice selection assistance information (S-NSSAI); and
receiving a response indicating whether the request to update is granted from the second entity.

2. The method of claim 1, wherein the first entity comprises an application function (AF).

3. The method of claim 1, wherein the information comprises an external group ID for a group of UEs, and a list of generic public subscription identifiers (GPSIs) for one or more members of the group of UEs.

4. The method of claim 3, wherein the at least one corresponding static IP address comprises a list of static IP addresses and corresponding IP versions for one or more members of the group of UEs.

5. The method of claim 3, wherein the information in the request to update comprises instructions to create, update, or delete at least one of group subscription data or UE subscription data in a unified data repository (UDR).

6. The method of claim 1, wherein the second entity comprises a network exposure function (NEF) or a unified data management (UDM).

7. The method of claim 1, wherein the information comprises one or more generic public subscription identifiers (GPSIs) for one or more particular UEs to be configured with static IP addresses.

8. The method of claim 6, further comprising allocating the corresponding static IP addresses in the request.

9. The method of claim 8, wherein allocating the corresponding static IP addresses comprises avoiding conflicting address allocations.

10. The method of claim 6, further comprising:
transmitting an allocation request with the GPSIs for the one or more particular UEs to a network entity; and
receiving one or more static IP addresses from the network entity in response to the allocation request.

11. The method of claim 10, further comprising:
storing a mapping table of the relation, the mapping table mapping the GPSIs to the one or more static IP addresses allocated by the network entity.

12. An method for wireless communications by a second entity, comprising:
receiving, from a first entity, a request to update a relation between at least one user equipment (UE) ID and at least one corresponding static UE internet protocol (IP) address for a protocol data unit (PDU) session, and
requesting an update of subscription data based on the relation received in the request.

13. The method of claim 12, further comprising:
receiving a data management query from a third entity; and
transmitting the update of subscription data in response to the data management query to the third entity.

14. The method of claim 13, wherein the third entity comprises a unified data repository (UDR).

15. The method of claim 12, further comprising:
transmitting, a response regarding the request to update the relation, to the first entity that the update of subscription data based on the relation has been submitted.

16. The method of claim 12, further comprising:
transmitting, a notification to a session management function (SMF), that the update of subscription data based on the relation has been submitted, wherein the notification triggers a release of a previous PDU session in response to the update of subscription data.

17. The method of claim 16, wherein the SMF identifies, in the notification, Subscription Permanent Identifier (SUPI), and the session management subscriber data to be updated.

18. The method of claim 12, wherein the request comprises an external group ID for a group of UEs, and a list of generic public subscription identifiers (GPSIs) for one or more members of the group of UEs.

19. The method of claim 18, wherein the at least one corresponding static IP address comprises a list of static IP addresses and corresponding IP versions for one or more members of the group of UEs.

20. The method of claim 18, wherein the request to update comprises instructions to create, update, or delete at least one of group subscription data or UE subscription data.

21. The method of claim 12, wherein the first entity comprises a network exposure function (NEF) and the second entity comprises a unified data management (UDM), the NEF receiving the relation from an application function (AF).

22. The method of claim 12, wherein the first entity comprises an application function (AF) and the second entity comprises a unified data management (UDM).

23. The method of claim 12, wherein the request comprises one or more generic public subscription identifiers (GPSIs) for one or more particular UEs to be configured with static IP addresses.

24. The method of claim 23, wherein the at least one corresponding static IP addresses in the request are allocated by the first entity.

25. The method of claim 24, wherein the allocation of the at least one corresponding static IP addresses avoids conflicting address allocations.

26. The method of claim 23, wherein at least one corresponding static IP addresses in the request are allocated by a network entity in response to requests by the first entity, wherein the relation is stored in a mapping table at the first entity, the mapping table mapping the GPSIs to the at least one corresponding static IP addresses allocated by the network entity.

27. An apparatus for wireless communications by a first entity, comprising:
a memory having executable instructions stored thereon; and
a processor configured to execute the executable instructions to cause the apparatus to:
provide information to a second entity in a request to update a relation between at least one user equipment (UE) identifier (ID) and at least one corresponding static internet protocol (IP) address for a protocol data unit (PDU) session to a data network name (DNN) of a single-network slice selection assistance information (S-NSSAI); and
receive a response indicating whether the request to update is granted from the second entity.

28. The apparatus of claim 27, wherein the first entity comprises an application function (AF).

29. An apparatus for wireless communications by a second entity, comprising:
a memory having executable instructions stored thereon; and
a processor configured to execute the executable instructions to cause the apparatus to:
receive, from a first entity, a request to update a relation between at least one user equipment (UE) ID and at least one corresponding static UE internet protocol (IP) address for a protocol data unit (PDU) session, and
request an update of subscription data based on the relation received in the request.

30. The apparatus of claim 29, wherein the first entity comprises an application function (AF) and the second entity comprises a unified data management (UDM).
